(19) United States
(12) Patent Application Publication
(10) Pub. No.: US 2013/0152373 A1
(43) Pub. Date: Jun. 20, 2013

(54) Method for Marking a Tool

(71) Applicant: Da-Sen LIN, Taichung City (TW)

(72) Inventor: Da-Sen LIN, Taichung City (TW)

(73) Assignee: PARD HARDWARE INDUSTRIAL CO., LTD., Taichung City (TW)

(21) Appl. No.: 13/693,017

(22) Filed: Dec. 3, 2012

(30) Foreign Application Priority Data
Dec. 19, 2011 (TW) 100147115

(51) Int. Cl. B23P 15/00; B21K 5/00

(52) U.S. Cl. CPC B23P 15/00; B21K 5/00
USPC 29/527.5; 29/527.1

(57) ABSTRACT

A method is disclosed for marking a tool. The includes the steps of forming a tool, making an indented mark in the tool, hardening the tool, coloring the tool to provide a color layer on the tool in and near the indented mark, clearing the tool of redundant colorant that overflows from the indented mark, black dying the tool to provide a black-dyed layer on the tool except the indented mark, and painting the tool to provide a transparent paint layer on the tool for glistering and rust-prevention.

### BACKGROUND OF INVENTION

1. Field of Invention

The present invention relates to a socket wrench and, more particularly, to a method for marking a socket of a socket wrench so that the socket bears a clear, durable and aesthetic mark.

2. Related Prior Art

An open-ended wrench, a box-ended wrench, a monkey wrench or a socket wrench may be used to drive a fastener such as a threaded bolt and a nut. A socket wrench kit includes a handle and a set of sockets of various sizes. In operation, the handle is connected to a selected one of the sockets for driving a fastener of a certain size. Thus, a socket wrench kit can be used to drive fasteners of various sizes. A socket wrench kit is lighter and less expensive than a set of open-ended wrenches or box-ended wrenches. The handle of a socket wrench kit often includes a selective one-way driving mechanism. Therefore, a socket wrench kit is more convenient than a monkey wrench.

It is important to mark the sockets of a socket wrench kit to indicate the sizes of the sockets. Conventionally, printing machines are used to print the sockets with marks. Such printing machines are however expensive. Moreover, the printed marks are unclear.

There has been an attempt to provide plastic collars of different colors on the sockets. The plastic collars could easily be blurred, damaged or detached from the sockets so that the sockets would be poorly marked or not marked at all.

Pressing machines may alternatively be used to indent the sockets with marks. Such pressing machines are however expensive. In addition, the indented marks are unclear. This problem will be even worse when the indented marks are filled with dirt and grease after some time of use.

A socket is generally provided with a coating via electroplating after the indented mark is made. The coating is provided on the socket in and outside the indented mark. The coating protects the socket from rust. The coating is however unclear since the color of the portion of the socket within the indented mark is identical to the color of the portion of the socket outside the indented mark.

A socket may alternatively be provided with manganese phosphate after the indented mark is made. The manganese phosphate protects the socket from rust. The manganese phosphate however makes the socket look black and blur the indented mark.

Therefore, the present invention is intended to obviate or at least alleviate the problems encountered in prior art.

### SUMMARY OF INVENTION

It is the primary objective of the present invention to provide an effective method for marking a tool.

To achieve the foregoing objective, the method includes the steps of forming a tool, making an indented mark in the tool, hardening the tool, coloring the tool to provide a color layer on the tool in and near the indented mark, clearing the tool of redundant colorant that overflows from the indented mark, black dying the tool to provide a black-dyed layer on the tool except the indented mark, and painting the tool to provide a transparent paint layer on the tool for glistering and rust-prevention.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flow chart of a method for marking a tool according to the preferred embodiment of the present invention;

FIG. 2 is a perspective view of a socket at the beginning of the method shown in FIG. 1;

FIG. 3 is a perspective view of the socket after a pressing step of the method shown in FIG. 1;

FIG. 4 is a partial, cross-sectional view of the socket after a coloring step of the method shown in FIG. 1;

FIG. 5 is a partial, cross-sectional view of the socket after a redundant colorant-removing step of the method shown in FIG. 1;

FIG. 6 is a partial, cross-sectional view of the socket after a black dying step of the method shown in FIG. 1;

FIG. 7 is a partial, cross-sectional view of the socket after a painting step of the method shown in FIG. 1; and

FIG. 8 is a perspective view of the socket shown in FIG. 7.

### DETAILED DESCRIPTION OF PREFERRED EMBODIMENT

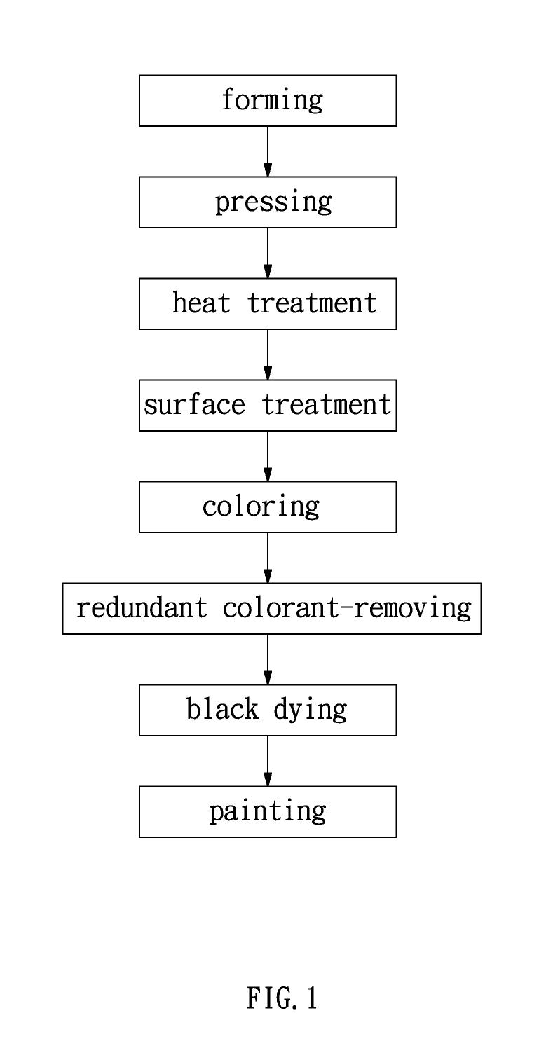

Referring to FIG. 1, there is shown a method for marking a tool according to the preferred embodiment of the present invention. The tool may be a socket, wrench, knife or screwdriver.

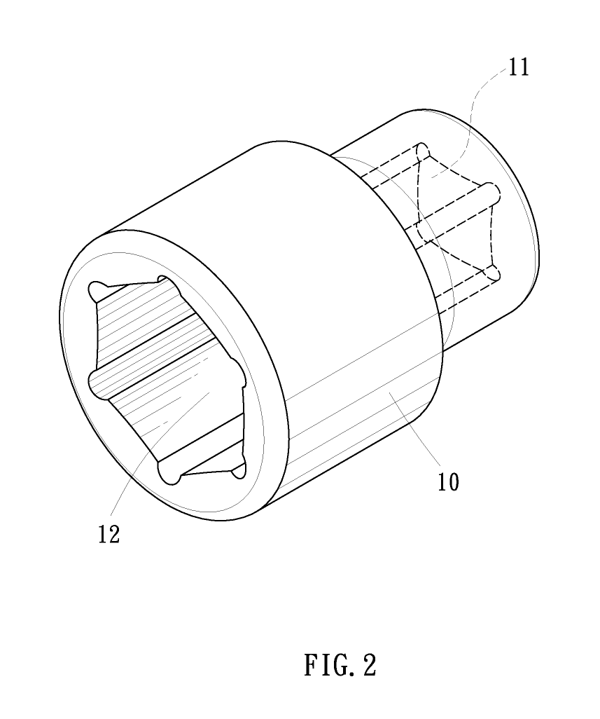

Referring to FIGS. 1 and 2, there is provided a tool 10 in the form of a socket for example. The tool 10 is made by lathing and/or casting for example. The tool 10 includes a square recess 11 in an end for receiving a portion of a handle of a socket wrench and a hexagonal recess 12 in an opposite end for receiving a nut or a head of a screw.

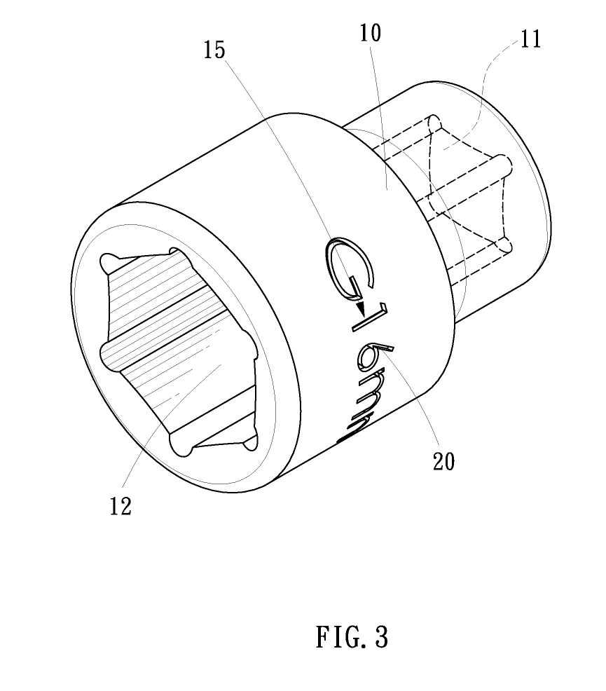

Referring to FIGS. 1 and 3, the tool 10 is made with at least one indented mark 15 by pressing, inscribing or molding for example. The indented mark 15 may be a word or number to represent the specification, the size, a trademark or the name of the manufacturer of the tool 10.

Referring to FIG. 1, thermal treatment is conducted on the tool 10 to increase the hardness of the tool 10. Thus, a portion of the tool 10 near the indented mark 15, in particular, is not vulnerable to wearing. Hence, the depth of the indented mark 15 is retained.

Referring to FIG. 1, surface treatment (or “finishing”) is conducted on the tool. The surface treatment is executed by sand-blasting or grinding to remove blurs from the tool 10 and the indented mark 15. The surface of the portion of the tool 10 in the indented mark 15 is made rough to facilitate attachment of colorant thereto.

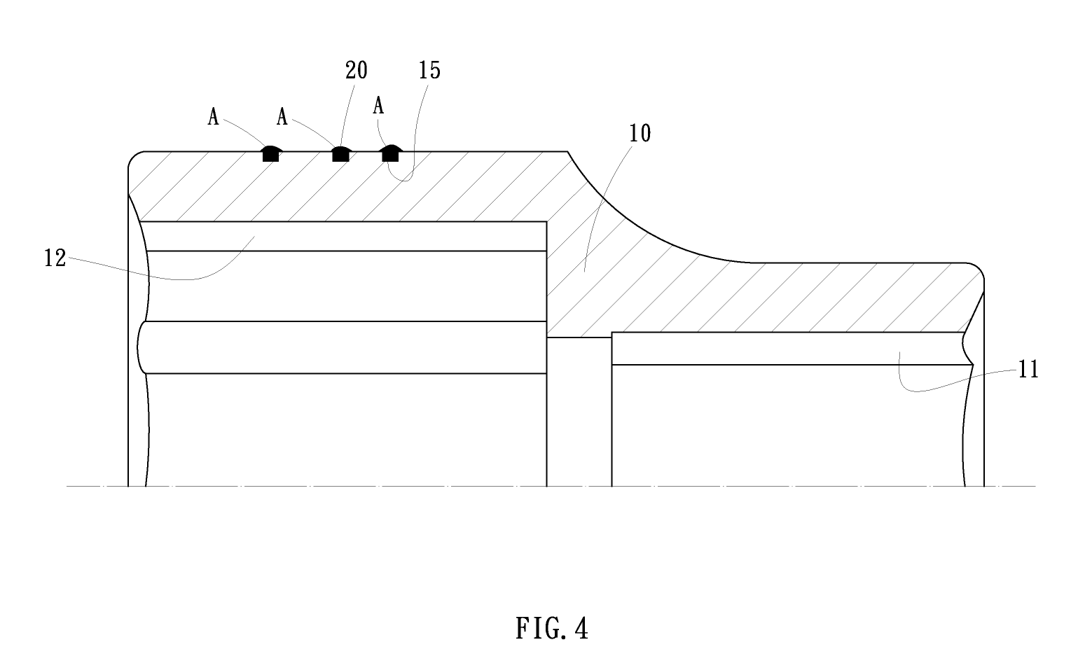

Referring to FIGS. 1 and 4, coloring is conducted on the tool 10 to form a color layer 20 on the tool 10 in and near the indented mark 15. The color layer 20 may be made of various colors of colorant such as red and green. The colorant is effectively attached to the surface of the portion of the tool 10 in the indented mark 15, which has been made rough. The indented mark 15 is filled with the colorant. The color layer 20 inevitably includes redundant colorant A overflowing from the indented mark 15.

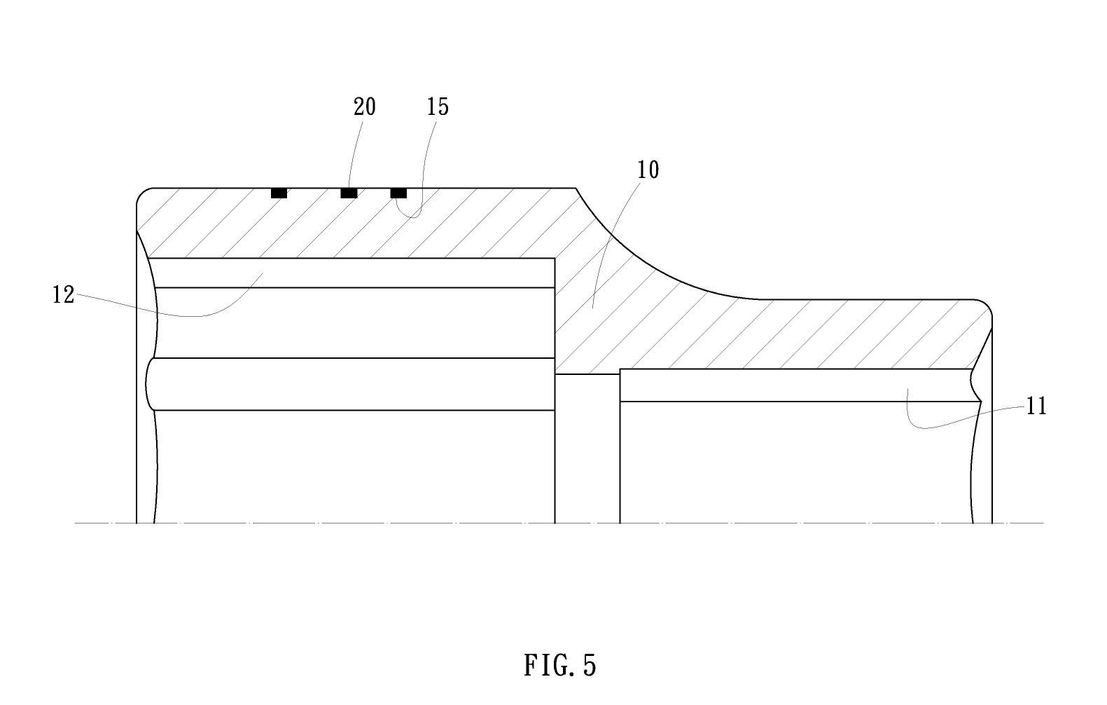

Referring to FIGS. 1 and 5, redundant colorant-removing is conducted on the tool 10. By grinding or vibrating, the redundant colorant A is removed from on the tool 10, leaving only the coolant in the indented mark 15.

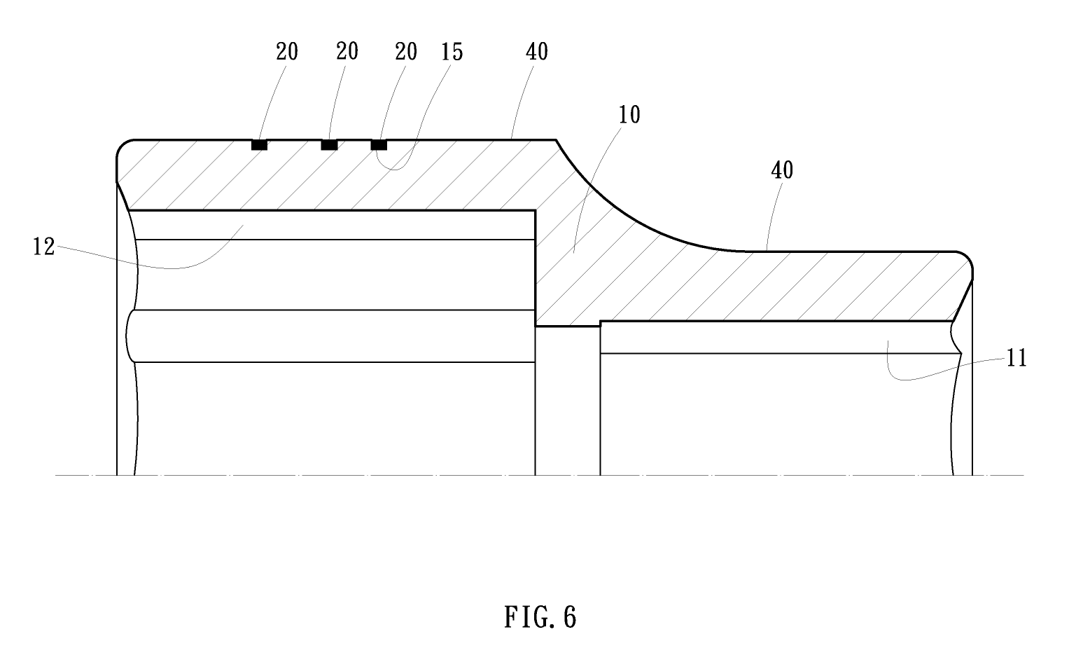

Referring to FIGS. 1 and 6, black dying is conducted on the tool 10. Black-dying or manganese phosphate is provided on the tool 10 to form a black-dyed layer 40 on the tool 10 except the color layer 20. The black-dyed layer 40 is in strong contrast against the color layer 20, which is in red or green for example. Hence, the color layer 20 looks clear amid the black-dyed layer 40

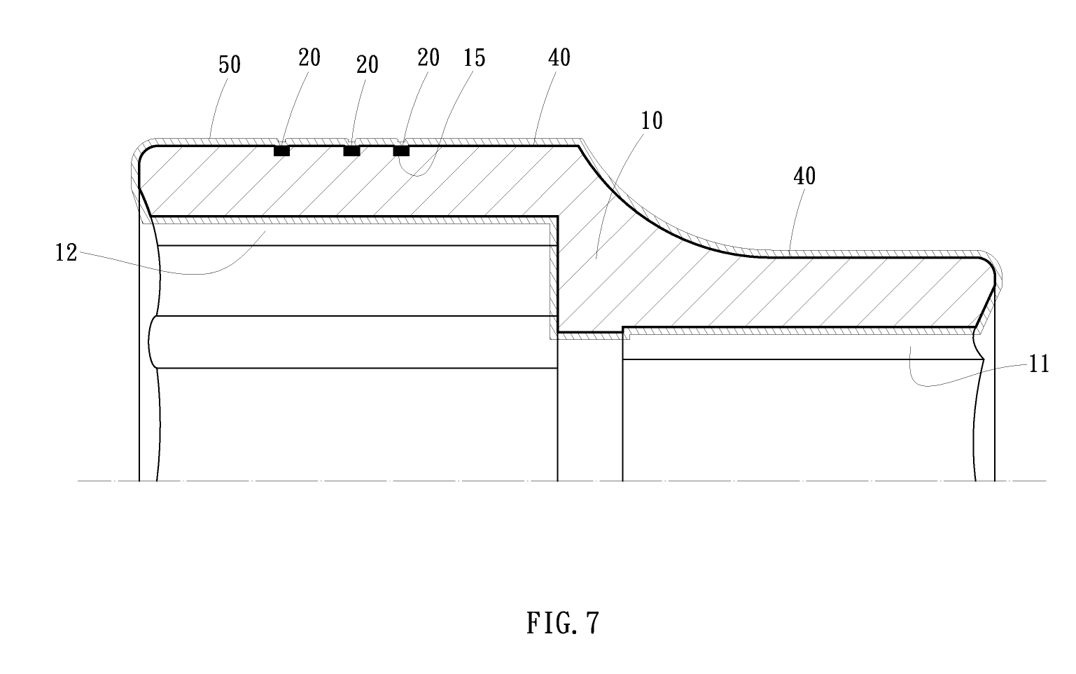

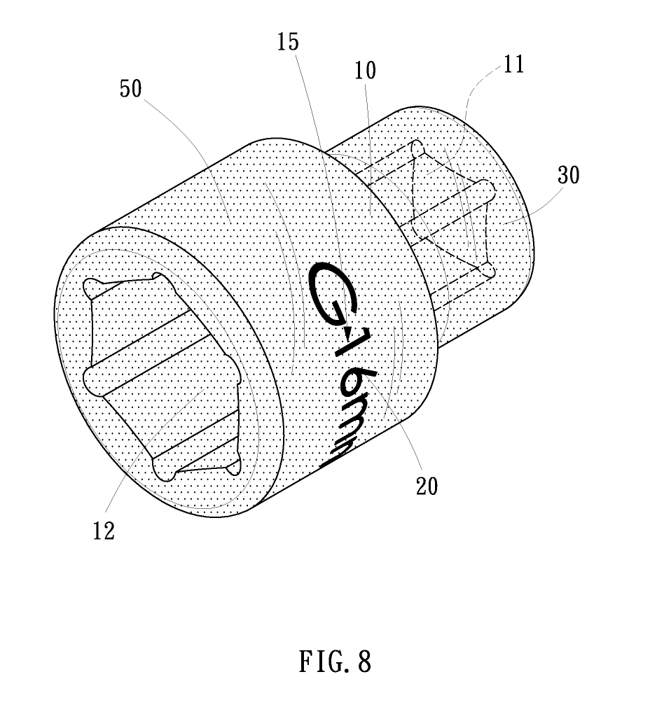

Referring to FIGS. 1 and 7, painting is conducted on the tool 10 to form a transparent paint layer 50 on the tool 10. The transparent paint layer 50 glisters and prevents rust. The transparent paint layer 50 protects the black-dyed layer 40 from rust and protects the color layer 20 in the indented mark 15 from peeling because of collision or rubbing. Hence, the indented mark 15 remains clear for long. Referring to FIG. 8, the resultant tool 10 is shown.

The tool 10 exhibits at least two advantages. At first, the tool 10 is made with the indented mark 15, and the indented mark 15 is provided with the color layer 20, which is isolative. The color layer 20 exists only in the indented mark 15 and attaches firmly to the tool 10, i.e., the color layer 20 does not peel from the indented mark 15 easily. The color layer 20 looks clear amid the black-dyed layer 40 since they are in strong contrast against each other. Hence, a user easily identifies the indented mark 15, which represents a word, number or pattern.

Secondly, both of the color layer 20 in the indented mark 15 and the black-dyed layer 40 outside the indented mark 15 are covered by the transparent paint layer 50. The transparent paint layer 50 protects the black-dyed layer 40 from rust and protects the color layer 20 in the indented mark 15 from blurring or peeling. Therefore, the indented mark 15 remains clear for long.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for marking a tool, the method including the steps of:
forming a tool;
making an indented mark in the tool;
hardening the tool;
coloring the tool to provide a color layer on the tool in and near the indented mark;
clearing the tool of redundant colorant A that overflows from the indented mark;
black dying the tool to provide a black-dyed layer on the tool except the indented mark; and
painting the tool to form a transparent paint layer on the tool for glistering and rust-prevention.

2. The method according to claim 1, further including the step of surface treatment between the steps of hardening and coloring to clear the tool of bur and roughen the indented mark.

3. The method according to claim 2, wherein the step of surface treatment is selected from the group consisting of sand-blasting and grinding.

4. The method according to claim 1, wherein the tool is selected from the group consisting of a socket, a wrench, a knife and a screwdriver.

5. The method according to claim 1, wherein the step of clearing the tool of redundant colorant A is selected from the group consisting of grinding and vibration.

6. The method according to claim 1, wherein the step of black dying is selected from the group consisting of black dying and provision of manganese phosphate.

7. The method according to claim 1, wherein the step of forming the tool is selected from the group consisting of latching and casting.

8. The method according to claim 1, wherein the step of providing the indented mark includes the step of pressing.

9. The method according to claim 1, wherein the step of hardening includes the step of heat treatment.
